(19) United States
(12) Patent Application Publication
(10) Pub. No.: US 2011/0243361 A1
(43) Pub. Date: Oct. 6, 2011

(54) SPEAKER SYSTEM

(75) Inventors: Toshiyuki Koike, Mie (JP); Hidekazu Tanaka, Singapore (SG); Soo Chen Lai, Singapore (SG); Thomas Chee Wee Leow, Singapore (SG)

(73) Assignee: MATSUSHITA ELECTRIC INDUSTRIAL CO., LTD., Osaka (JP)

(21) Appl. No.: 12/281,553

(22) PCT Filed: Mar. 31, 2006
(86) PCT No.: PCT/JP2006/306842

§ 371 Date: Oct. 23, 2008

(51) Int. Cl. H04R 1/02

(52) U.S. Cl. 381/386

(57) ABSTRACT

A loudspeaker device includes an enclosure, a loudspeaker unit and a passive radiator both mounted to the enclosure. The passive radiator includes an edge sandwiched and bonded between a first diaphragm and a second diaphragm. This structure allows increasing the bonding strength between the edge and the first diaphragm as well as between the edge and the second diaphragm, so that the loudspeaker device can withstand greater maximum inputs and reproduce quality bass sound.

### TECHNICAL FIELD

The present invention relates to a loudspeaker device, having a passive radiator, to be used in a video apparatus such as a thin and large size television receiver.

### BACKGROUND ART

In recent years, a large size screen employing a plasma panel or a liquid crystal panel has been used in a television receiver featuring a thin body, and the large size and thin TV receivers have been well accepted in the market. This market trend requires that audio reproduction devices be downsized and thinner. At the same time, a home theater and the terrestrial digital broadcasting have prevailed in the market, and these media are capable of carrying quality sound. This market trend also requires that the audio reproduction devices reproduce quality sound and withstand greater maximum inputs.

One of the requests of reproducing the quality sound needs a reproduction technique of bass sound in order to reproduce dynamic sound incidental to cinemas. For instance, use of a passive radiator is one of the reproduction techniques of bass sound.

FIG. 7 shows a lateral sectional view of a conventional loudspeaker device having a passive radiator. Enclosure 1 has two openings 4a and 4b at its front, and loudspeaker unit 2 with magnetic circuit 2a is mounted to opening 4a. Passive radiator 3 is formed of flat diaphragm 3b and mounted to opening 4b via edge 3a supporting passive radiator 3.

In the conventional loudspeaker device discussed above, loudspeaker unit 2 produces exhaust pressure when it is driven, and this exhaust pressure is used for driving passive radiator 3. The drive of radiator 3 reinforces the reproduction of predetermined bass sound. This kind of conventional loudspeaker device is disclosed in, e.g. Unexamined Japanese Utility Model Publication No. S57-2790.

Diaphragm 3b and edge 3a are typically jointed with an adhesive, or by a molding resin. In the case of the molding resin, edge 3a is unitarily molded with diaphragm 3b through an outsert molding method. On the other hand, only diaphragm 3b is sometimes formed by cutting a board or through a molding process, and then diaphragm 3b is bonded to edge 3a. Since this bonding method needs no mold-die, it is advantageous cost-wise over the other method.

However, a stronger joint section between diaphragm 3b and edge 3a is required in the environment where larger and thinner video apparatuses as well as greater output from audio apparatuses are awaited.

### DISCLOSURE OF INVENTION

A loudspeaker device of the present invention includes an enclosure, a loudspeaker and a passive radiator both mounted to the enclosure. The passive radiator includes a first diaphragm, a second diaphragm, and an edge, whose inner periphery is sandwiched and bonded between the first and the second diaphragms, and outer periphery is fixed to the enclosure. The foregoing structure allows strengthening the joint sections between the edge and the diaphragms, so that the loudspeaker device for reproducing bass sound can withstand greater maximum inputs.

### BRIEF DESCRIPTION OF THE DRAWINGS

FIG. 1 shows a lateral sectional view of a loudspeaker device in accordance with an embodiment of the present invention.

FIG. 2 shows a lateral sectional view of a passive radiator to be used in the loudspeaker device shown in FIG. 1.

FIG. 3 shows an exploded perspective view of the passive radiator shown in FIG. 2.

FIG. 4 shows a lateral sectional view of a passive radiator to be used in a loudspeaker device in accordance with another embodiment of the present invention.

FIG. 5 shows a sectional view of the passive radiator cut along line 5-5 shown in FIG. 4.

FIG. 6 shows a lateral sectional view of a passive radiator to be used in a loudspeaker device in accordance with still another embodiment of the present invention.

FIG. 7 shows a lateral sectional view of a conventional loudspeaker device.

### DESCRIPTION OF REFERENCE MARKS

11 enclosure
11a, 11b opening
12 loudspeaker unit
12a magnetic circuit
12b magnetic gap
12c bottom plate
12d magnet
12e top plate
13 passive radiator
13a frame
13b edge
13c second diaphragm
13d first diaphragm
13e through-hole
13f, 13k ridge
13i tapped hole
13j opening

### DESCRIPTION OF PREFERRED EMBODIMENTS

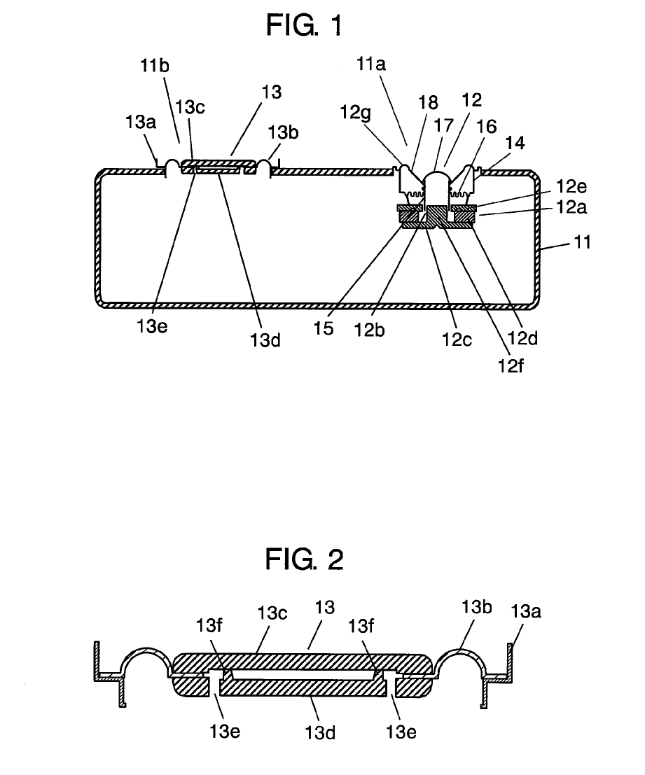

Exemplary embodiments of loudspeaker devices of the present invention are demonstrated hereinafter with reference to FIG. 1-FIG. 6.

### Embodiment 1

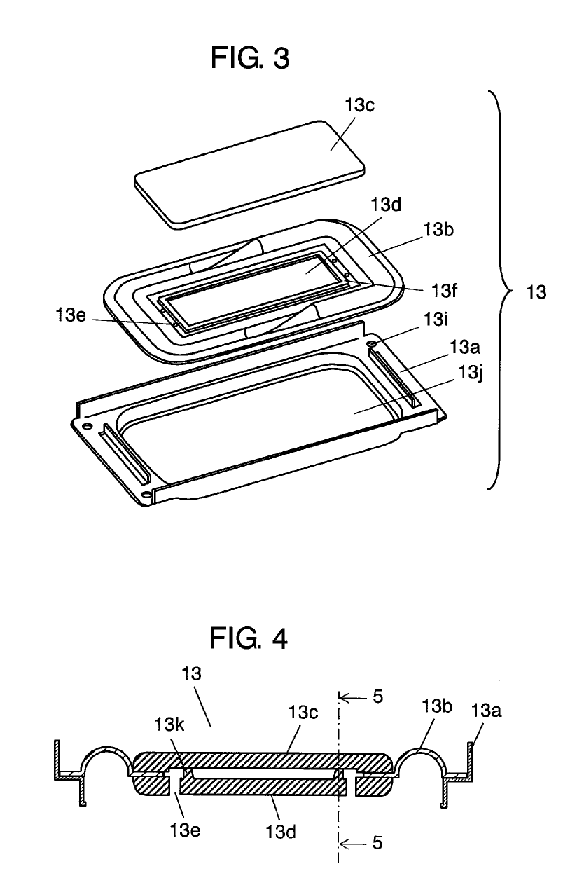

FIG. 1 shows a lateral sectional view of a loudspeaker device in accordance with the first embodiment of the present invention. FIG. 2 shows a lateral sectional view of a passive radiator to be used in the loudspeaker device shown in FIG. 1, and FIG. 3 shows an exploded perspective view of the passive radiator shown in FIG. 2.

As shown in FIG. 1-FIG. 3, enclosure 11 has two openings 11a and 11b at its front. Loudspeaker unit 12 is screwed down (not shown) to opening 11a, and rectangular passive radiator 13 is mounted to opening 11b.

Loudspeaker unit 12 includes magnetic circuit 12a for forming magnetic gap 12b, loudspeaker diaphragm 18 (hereinafter referred to as diaphragm 18), suspension 16, and dust cap 17. Magnetic circuit 12a is formed by bonding bottom plate 12c, annular magnet 12d and annular top plate 12e together. Bottom plate 12c includes center pole 12f. Diaphragm 18 is bonded to loudspeaker frame 14 (hereinafter simply referred to as frame 14) at its outer periphery, and an inner periphery thereof is bonded to voice coil 15. Magnetic gap 12b is formed at an end of voice coil 15. Suspension 16 is bonded to voice coil 15 at its inner periphery, and an outer periphery thereof is bonded to frame 14. Dust cap 17 covers voice coil 15 from the top. Frame 14 is bonded to top plate 12e at its bottom.

Passive radiator 13 includes frame 13a, edge 13b, first diaphragm 13d (hereinafter referred to as diaphragm 13d), and second diaphragm 13c (hereinafter referred to as diaphragm 13c). Frame 13a is made of thin metal sheet, and has rectangular opening 13j, and tapped hole 13i for mounting passive radiator 13 to enclosure 11. Edge 13b works as a supporter of diaphragms 13c and 13d for bonding diaphragms 13c and 13d to frame 13a at their outer periphery. Diaphragm 13c is made of rectangular plate molded of resin, and placed on the inner periphery of edge 13b. Diaphragm 13c is disposed at an outer surface of enclosure 11 and faces outside of enclosure 11. Diaphragm 13d is also made of rectangular plate molded of resin, and placed on the inner periphery of edge 13b and faces inside of enclosure 11.

Edge 13b is bonded to diaphragm 13c, edge 13b is also bonded to diaphragm 13d with adhesive, and edge 13b is sandwiched between diaphragms 13c and 13d.

As discussed above, edge 13b is sandwiched between and bonded to diaphragms 13c and 13d, so that the joint strength between edge 13b and diaphragm 13c as well as between edge 13b and diaphragm 13d increases. As a result, passive radiator 13 can withstand greater maximum inputs, and the loudspeaker device to be used for reproducing bass sound is thus obtainable with improved withstanding characteristics to the greater maximum inputs.

On top of that, a plurality of through-holes 13e is formed at a vicinity of a joint section between diaphragm 13d and edge 13b. In FIG. 3, through-holes 13e are formed along a short side of diaphragm 13d; however, they can be formed along a long side of diaphragm 13d, or they can be formed along both of the short and the long sides. Through-holes 13e are formed with a strength of diaphragm 13d being kept, i.e. they do not extremely decrease the strength of diaphragm 13d, and a formation of through-holes 13e can be appropriately selected depending on the necessity. For instance, a size of through-hole 13e, an interval between the respective through-holes 13e, a place of through-hole 13e, and numbers of through-holes 13e can be appropriately selected.

A presence of through-holes 13e gives adhesive greater opportunities of exposing themselves to an open air, where an adhesive is used for the joint section between diaphragm 13c and edge 13b as well as between diaphragm 13d and edge 13b. Because the open air enters into through-holes 13e and contacts with the adhesive applied between diaphragm 13c and edge 13b as well as between diaphragm 13d and edge 13b. The open air accelerates the adhesive to vaporize its solvent, so that dispersion in drying times of the respective joint sections can be improved, and a drying time can be shortened. As a result, a productivity of passive radiator 13 can be improved.

Diaphragm 13d includes ridge 13f along its entire periphery inside the joint section between diaphragm 13d and edge 13b. Ridge 13f is formed such that it can maintain the holding mechanism between edge 13b and diaphragm 13c as well as between edge 13b and diaphragm 13d. In other words, a height of ridge 13f is set appropriately to produce a pressure great enough for holding edge 13b sandwiched between diaphragms 13c and 13d.

A presence of ridge 13f forms a space corresponding to the height of ridge 13f between diaphragm 13c and diaphragm 13d. This space allows the adhesive between diaphragm 13c and edge 13b as well as between diaphragm 13d and edge 13b to increase an area contacting with the open air, so that the solvent contained in the adhesive is accelerated to vaporize along the entire periphery of diaphragm 13d via through-holes 13e. As a result, the dispersion in drying time is reduced, and the drying time is shortened.

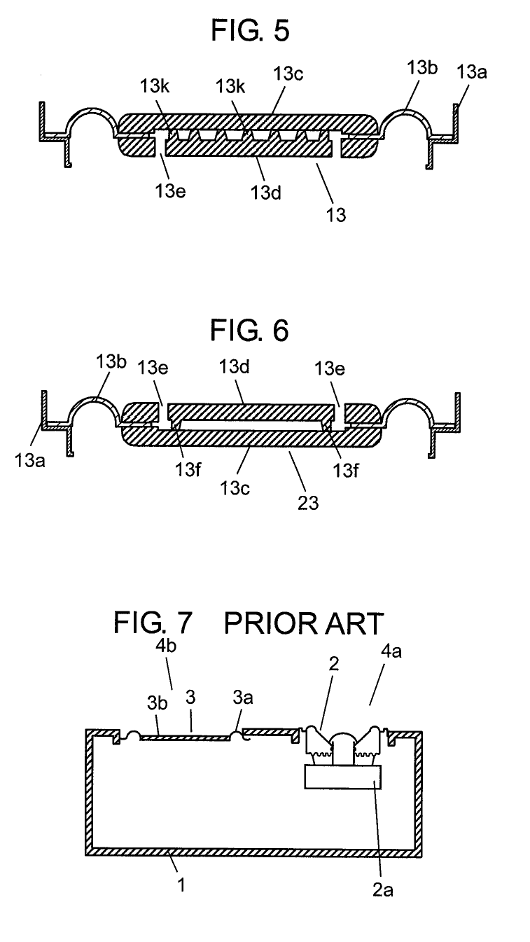

FIG. 4 shows a lateral sectional view of a passive radiator in accordance with another embodiment. FIG. 5 shows a sectional view of the passive radiator cut along line 5-5 shown in FIG. 4. The ridge is not necessarily formed on the entire outer periphery of diaphragm 13d. For instance, it can be formed intermittently like ridges 13k. A formation of intermittent ridges 13k can be selected appropriately depending on the necessity. For instance, a length and a size, intervals between the respective ridges 13k, places, and numbers of ridges 13k can be selected appropriately when ridges 13k are disposed intermittently.

As discussed above, edge 13b is bonded to diaphragm 13c at a first face of its inner periphery and bonded to diaphragm 13d at a second face of its inner periphery with the adhesive. Edge 13b is thus sandwiched between diaphragms 13c and 13d. This structure allows increasing the bonding strength between edge 13b and diaphragm 13c as well as between edge 13b and diaphragm 13d, so that passive radiator 13 improves its withstanding characteristics to greater maximum inputs. As a result, the loudspeaker device for reproducing the bass sound improves its withstanding characteristics to the greater maximum inputs.

In the case of providing through-holes 13e to diaphragm 13d in addition to intermittent ridges 13k, the open air is supplied via through-holes 13e, thereby accelerating the adhesive to vaporize the solvent. This structure allows shortening the drying time of the adhesive. As a result, the productivity of passive radiator 13 is improved, which also improves the productivity of the loudspeaker device.

On top of that, ridge 13f or ridges 13k formed on diaphragm 13d allow forming a space between diaphragms 13c and 13d. This structure allows the adhesive at the respective joint sections to expose themselves in greater areas to the open air entering into through-holes 13e, so that the drying time of the adhesive can be shortened and the adhesive can be dried uniformly. As a result, the productivity of the loudspeaker device can be improved.

FIG. 6 shows a lateral sectional view of a passive radiator in accordance with still another embodiment. In the foregoing description, through-holes 13e are provided to diaphragm 13d, and diaphragm 13d is placed on the inner periphery of edge 13b and faces inside of enclosure 11. However, as shown in FIG. 6, first diaphragm 13d can be placed on the inner periphery of edge 13b, and is disposed at the outer surface and faces outside of enclosure 11. As shown in FIG. 6, second diaphragm 13c can be placed on the inner periphery of edge 13b, and is disposed inside enclosure 11 and faces inside of enclosure 11. Passive radiator 23 employing this structure has through-holes 13e provided to the outer surface of enclosure 11. In this case, dust entering between diaphragms 13c and 13d is preferably taken into consideration, or a dust-proof countermeasure is preferably taken. For instance, after the adhesive, which bonds edge 13b to diaphragm 13c as well as edge 13b to diaphragm 13d, is dried, application of adhesive (not shown) for sealing through-holes 13e is one of the dust-proof countermeasures.

In the previous discussions, through-holes 13e, ridge 13f or ridges 13k are formed on diaphragm 13d. In this case, diaphragm 13c remains a simple flat plate, so that diaphragm 13c can be formed with ease and its manufacturing cost stays at a low level.

However, through-holes 13e can be formed on diaphragm 13d, and ridge 13f or ridges 13k can be formed on diaphragm 13c. In this case, diaphragms 13c and 13d maintain their mechanical strength and accuracy, while the appropriate places of through-holes 13e, ridge 13f or ridges 13k can be determined with ease for drying the adhesive.

### INDUSTRIAL APPLICABILITY

A loudspeaker device of the present invention allows its passive radiator to withstand greater maximum inputs, so that the loudspeaker device can be used for reproducing bass sound not only of electronic apparatuses such as audio-video apparatuses, game apparatuses but also of on-vehicle apparatuses.

1. A loudspeaker device comprising:
an enclosure;
a loudspeaker unit mounted to the enclosure; and
a passive radiator mounted to the enclosure, wherein the passive radiator includes:
a first diaphragm;
a second diaphragm; and
an edge whose inner periphery is bonded to the first diaphragm and the second diaphragm, and outer periphery is fixed to the enclosure.

2. The loudspeaker device of claim 1,
wherein the first diaphragm includes a plurality of through-holes.

3. The loudspeaker device of claim 2,
wherein the first diaphragm further includes a ridge disposed inwardly from the through-holes, and
the ridge is formed along an entire outer periphery of the first diaphragm.

4. The loudspeaker device of claim 2,
wherein the first diaphragm further includes a ridge disposed inwardly from the through-holes, and
the ridge is formed intermittently along an entire outer periphery of the first diaphragm.

5. The loudspeaker device of claim 1,
wherein the first diaphragm is disposed and faces inside of the enclosure.

6. The loudspeaker device of claim 1,
wherein the first diaphragm is disposed at an outer surface and faces outside of the enclosure.

7. The loudspeaker device of claim 2,
wherein the first diaphragm is disposed and faces inside of the enclosure.

8. The loudspeaker device of claim 3,
wherein the first diaphragm is disposed and faces inside of the enclosure.

9. The loudspeaker device of claim 4,
wherein the first diaphragm is disposed and faces inside of the enclosure.

10. The loudspeaker device of claim 2,
wherein the first diaphragm is disposed at an outer surface and faces outside of the enclosure.

11. The loudspeaker device of claim 3,
wherein the first diaphragm is disposed at an outer surface and faces outside of the enclosure.

12. The loudspeaker device of claim 4,
wherein the first diaphragm is disposed at an outer surface and faces outside of the enclosure.
